(19) United States
(12) Patent Application Publication
(10) Pub. No.: US 2013/0044811 A1
(43) Pub. Date: Feb. 21, 2013

(54) Content-Based Adaptive Control of Intra-Prediction Modes in Video Encoding

(71) Applicant: Hyung Joon Kim, McKinney, TX (US)

(72) Inventor: Hyung Joon Kim, McKinney, TX (US)

(21) Appl. No.: 13/212,182

(22) Filed: Aug. 18, 2011

(51) Int. Cl. H04N 7/26

(52) U.S. Cl. 375/240.12; 375/E07.243

(57) ABSTRACT

A method for encoding a video sequence in a video encoder is provided that includes receiving a picture in the video sequence, selecting an intra-prediction set for the picture from a plurality of intra-prediction sets based on activity in a previous picture in the video sequence, wherein the intra-prediction set is a subset of intra-prediction block sizes and modes of the video encoder, and coding the picture using the set of intra-prediction block sizes and modes for intra-prediction of macroblocks in the picture.

### BACKGROUND OF THE INVENTION

1. Field of the Invention

Embodiments of the present invention generally relate to a method and apparatus for content-based adaptive control of intra-prediction modes in video encoding.

2. Description of the Related Art

The demand for digital video products continues to increase. Some examples of applications for digital video include video communication, security and surveillance, industrial automation, and entertainment (e.g., DV, HDTV, satellite TV, set-top boxes, Internet video streaming, video gaming devices, digital cameras, cellular telephones, video jukeboxes, high-end displays and personal video recorders). Further, video applications are becoming increasingly mobile as a result of higher computation power in handsets, advances in battery technology, and high-speed wireless connectivity.

Video compression, i.e., video coding, is an essential enabler for digital video products as it enables the storage and transmission of digital video. In general, video coding standards such as MPEG-2, MPEG-4, H.264/AVC, etc. and the standard currently under development, HEVC, define a hybrid video coding technique of block motion compensation (prediction) plus transform coding of prediction error. Block motion compensation is used to remove temporal redundancy between successive pictures (frames or fields) by prediction from prior pictures, whereas transform coding is used to remove spatial redundancy within each block of a picture. In such techniques, pictures may be intra-coded, i.e., predicted from macroblocks in the same picture, or inter-coded, i.e., predicted from a previous picture or predicted from a previous picture and a following picture.

Intra-prediction of macroblocks improves encoding efficiency significantly by exploiting spatial correlation with adjacent pixels in the same picture. In general, for intra-prediction, a macroblock is divided into smaller partitions, i.e., blocks, and the coding costs for the smaller blocks are computed for some number of prediction modes defined for the particular block size.

A video coding standard may define multiple block sizes for intra-prediction and multiple prediction modes for each block size. For example, H.264/AVC specifies three intra-prediction block sizes for luma components of a macroblock, each with multiple intra-prediction modes, i.e., 16×16 with four intra-prediction modes, 8×8 with nine intra-prediction modes, and 4×4 with nine intra-prediction modes. For chroma components of a macroblock, a single intra-prediction block size, 8×8, with four intra-prediction modes is specified. In general, the best intra-coding cost is found by performing all of the luma intra-prediction searches for each possible chroma intra-prediction mode. This means that 736 different coding costs calculations are performed for each macroblock to find the best intra-prediction block size and mode. The emerging ITU-T/ISO High Efficiency Video Coding (HEVC) standard currently specifies even more luma intra-prediction block sizes and modes, i.e., prediction block sizes of 4×4 with 17 intra-prediction modes, 8×8 with 34 intra-prediction modes, 16×16 with 34 intra-prediction modes, 32×32 with 34 intra-prediction modes, and 64×64 with 34 intra-prediction modes.

### SUMMARY

Embodiments of the present invention relate to a method, digital system, and computer readable medium that provide for encoding a video sequence with content-based adaptive control of intra-prediction modes. The adaptive control of the intra-prediction modes includes selecting an intra-prediction set for the picture from a plurality of intra-prediction sets based on activity in a previous picture in the video sequence, wherein the intra-prediction set is a subset of intra-prediction block sizes and modes of the video encoder, and coding the picture using the set of intra-prediction block sizes and modes for intra-prediction of macroblocks in the picture.

### BRIEF DESCRIPTION OF THE DRAWINGS

Particular embodiments will now be described, by way of example only, and with reference to the accompanying drawings:

FIG. 1 shows a block diagram of a digital system;

FIGS. 2A and 2B show block diagrams of a video encoder;

FIG. 3 shows a flow diagram of a method; and

FIG. 4 shows a block diagram of an illustrative digital system.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

As used herein, the term “picture” refers to a frame or a field of a frame. A frame is a complete image captured during a known time interval. When a video sequence is in progressive format, the term picture refers to a complete frame. When a video sequence is in interlaced format, each frame is composed of a field of odd-numbered scanning lines followed by a field of even-numbered lines. Each of these fields is a picture. Further, the term macroblock as used herein refers to a block of image data in a picture used for block-based video encoding. One of ordinary skill in the art will understand that the size and dimensions of a macroblock are defined by the particular video coding standard in use and thus may vary, and that different terminology may be used to refer to such a block.

In general, the luma intra-prediction modes for the larger prediction block sizes, e.g., 16×16 intra-prediction modes, are more suitable for flat or smooth macroblocks, i.e., macroblocks with little variation in pixel values, and the luma intra-prediction modes for smaller prediction block sizes, e.g., 8×8 and 4×4, are more appropriate for macroblocks that have more detail, i.e., higher variation in pixel values. Examination of all luma intra-prediction block sizes and modes when intra-predicting a macroblock yields the best intra-prediction result. However, this exhaustive search is computationally expensive and may not provide the best tradeoff between encoding efficiency and computational complexity. For example, if most of the macroblocks in a picture are smooth or have very simple texture, the picture can be efficiently encoded with acceptable quality by considering a subset of the intra-prediction modes of the larger luma intra-prediction block sizes, e.g., the 16×16 and 8×8 block sizes.

In addition, performing the exhaustive search is inefficient for inter-coded pictures when a small percentage of the macroblocks in such pictures are encoded with an intra-prediction mode. For example, if there is a very small number of intra-coded macroblocks in an inter-predicted picture with static or very low motion, examining a minimal set of the intra-prediction modes can save significant computational complexity without noticeable quality degradation.

Embodiments of the invention provide content-based adaptive control over which intra-prediction block sizes and modes are searched when encoding macroblocks in a picture. The adaptive control is based on the measured activity of intra-coded macroblocks in encoded pictures. More specifically, a set of intra-prediction block sizes and modes for a picture, i.e., an intra-prediction set, is selected based on a measure of the activity of intra-coded macroblocks in the previously encoded picture. Computation of this activity measure and the selection of the intra-prediction set are explained in more detail herein. The selected intra-prediction set is then used for intra-prediction of macroblocks during encoding of the picture. That is, for intra-prediction of each macroblock in the picture, only the intra-prediction block sizes and modes in the selected intra-prediction set are searched. As the picture is coded, statistics regarding the activity of intra-coded macroblocks in the picture are accumulated for use in computing the activity measure and selecting the intra-prediction set for the next picture. As is discussed in more detail below, this adaptive control reduces computational complexity during intra-prediction while maintaining encoding efficiency.

The term activity as used herein refers to the variation in the values of pixels contained in a macroblock, also referred to as the texture of a macroblock. Thus, in general, a macroblock with higher activity has greater variation in pixel values while a macroblock with lower activity has less variation in pixel values.

The measure of the activity of intra-coded macroblocks in an encoded picture, IntraMB_Act, is defined as

IntraMB_Act=AvgAct_IntraMB*Percent_IntraMB

where AvgAct_IntraMB is the average activity of intra-coded macroblocks in the encoded picture and Percent_IntraMB is the percentage of macroblocks in the encoded picture that were intra-coded. The average activity AvgAct_IntraMB is defined as

AvgAct_IntraMB=SumAct_IntraMB/Num_IntraMB (1)

where SumAct_IntraMB is the sum of the activity of the intra-coded macroblocks in the encoded picture and Num_IntraMB is the number of macroblocks in the encoded picture that were intra-coded.

The activity of an intra-coded macroblock, Act_IntraMB, may be measured in any suitable way. Some suitable techniques for determining macroblock activity include, but are not limited to, computing the magnitude of the horizontal pixel difference, computing the absolute sum of the vertical pixel difference, computing the absolute sum of horizontal and vertical differences, computing the weighted sum of horizontal and/or vertical pixel differences, computing the squares of horizontal and/or vertical pixel differences, and computing the transformed coefficient differences. For example, the macroblock activity may be computed as

Act_IntraMB=Act_IntraMB_Hor+Act_IntraMB_Ver (2)

where

Act_IntraMB_Hor=ΣΣabs(pixel(x,y)−pixel(x+1,y)) (x=0˜14, y=0˜15),

Act_IntraMB_Ver=ΣΣabs(pixel(x,y)−pixel(x,y+1)) (x=0˜15, y=0˜14).

The percentage of intra-coded macroblocks, Percent_IntraMB, is defined as

Percent_IntraMB=100*Num_IntraMB/TotalNum_MB (3)

where TotalNum_MB is the total number of macroblocks in the picture.

Accordingly, the measure of the activity of intra-coded macroblocks, IntraMB_Act, may be computed as

$$\begin{matrix}IntraMB\_Act = AvgAct\_IntraMB * Percent\_IntraMB \\ = ( \frac{SumAct\_IntraMB}{Num\_IntraMB} ) * ( \frac{100 * Num\_IntraMB}{TotalNum\_MB} ) \\ = \frac{100 * SumAct\_IntraMB}{TotalNum\_MB}\end{matrix} \qquad ( 4 )$$

The activity measure, IntraMB_Act, determines which of N predetermined intra-prediction sets is selected for a picture. More specifically, an intra-prediction set is selected from the N predetermined intra-prediction sets based on a range of texture (activity) the inter-prediction set is defined to handle. As was previously discussed, larger prediction block sizes are more suitable for flat or smooth macroblocks and smaller prediction block sizes are more suitable for macroblocks with more texture. Accordingly, as activity in intra-predicted macroblocks increases, more prediction block sizes and prediction modes are needed to provide acceptable intra-prediction quality. Thus, an inter-prediction set for a lower activity range will include a subset of the larger intra-prediction block sizes and modes while an inter-prediction set for a higher activity range will include all the intra-prediction block sizes and modes of the intra-prediction sets for any lower activity ranges plus some additional intra-prediction block sizes and/or modes. An example of six intra-prediction sets with activity ranges is shown in Table 1. This example assumes an H.264/AVC video encoder.

TABLE 1

| Set No. | Block Sizes(Modes) | Activity Range |
|---|---|---|
| 0 | 16×16 (0-3) | <100 |
| 1 | 16×16(0-3), 8×8(0-4) | 100-499 |
| 2 | 16×16(m0-3), 8×8(0-8), 4×4(0) | 500-4999 |
| 3 | 16×16(0-3), 8×8(0-8), 4×4(0-2) | 5000-11999 |
| 4 | 16×16(0-3), 8×8(0-8), 4×4(0-4) | 12000-29999 |
| 5 | 16×16(0-3), 8×8(0-8), 4×4(0-8) | >29999 |

An intra-prediction set is selected for a picture when the activity measure IntraMB_Act falls within the activity range of the intra-prediction set. For example, the selection of an intra-prediction set based on the activity measure IntraMB_Act may be performed as per the example pseudo code of Table 2. Note that this example pseudo code compares IntraMB_Act to various activity thresholds, Threshold(0) . . . Threshold (N−1). These activity thresholds bound the activity ranges of the intra-prediction sets.

TABLE 2
If IntraMB_Act < Threshold(0), then use IntraModeSet0)
Else If IntraMB_Act < Threshold(1), then use IntraModeSet(1)
Else If IntraMB_Act < Threshold(2), then use IntraModeSet(2)
...
Else If IntraMB_Act < Threshold(n), then use IntraModeSet(n)
Else If IntraMB_Act < Threshold(n+1), then use
IntraModeSet(n+1)
...
Else If IntraMB_Act < Threshold(N−2), then use IntraModeSet(N−2)
Else then use IntraModeSet(N−1)

The number N of predetermined intra-prediction sets, the block sizes/modes included in each set, and the activity ranges and/or N−1 activity thresholds may be empirically determined based on criteria such as the characteristics of the expected video sequences, the desired tradeoff between quality and computational complexity, and/or the processing capabilities of the video encoding hardware.

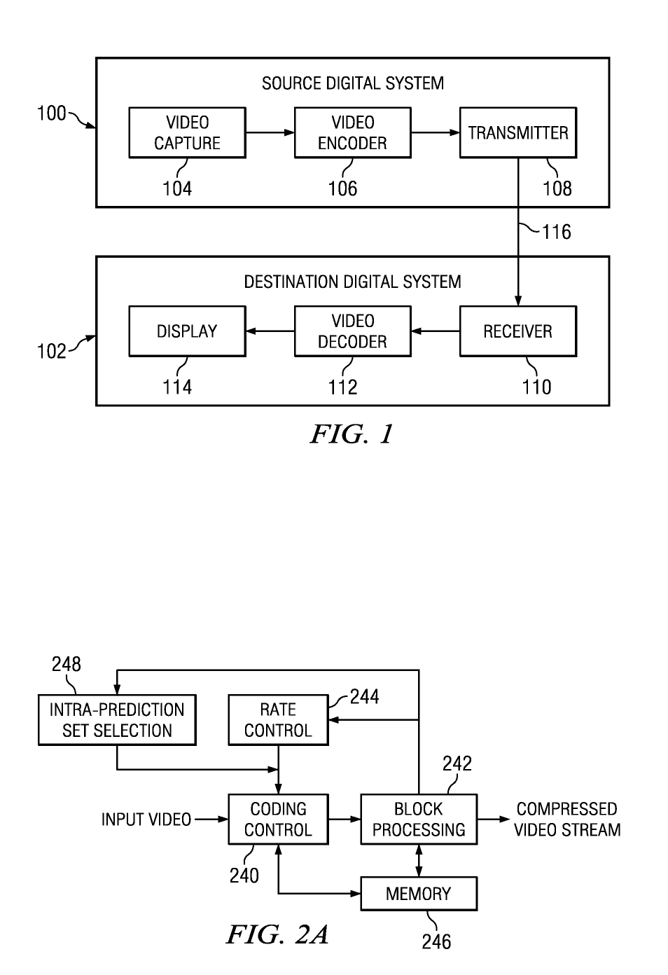

FIG. 1 shows a block diagram of a digital system. The system includes a source digital system 100 that transmits encoded video sequences to a destination digital system 102 via a communication channel 116. The source digital system 100 includes a video capture component 104, a video encoder component 106 and a transmitter component 108. The video capture component 104 is configured to provide a video sequence to be encoded by the video encoder component 106. The video capture component 104 may be for example, a video camera, a video archive, or a video feed from a video content provider. In some embodiments, the video capture component 104 may generate computer graphics as the video sequence, or a combination of live video, archived video, and/or computer-generated video.

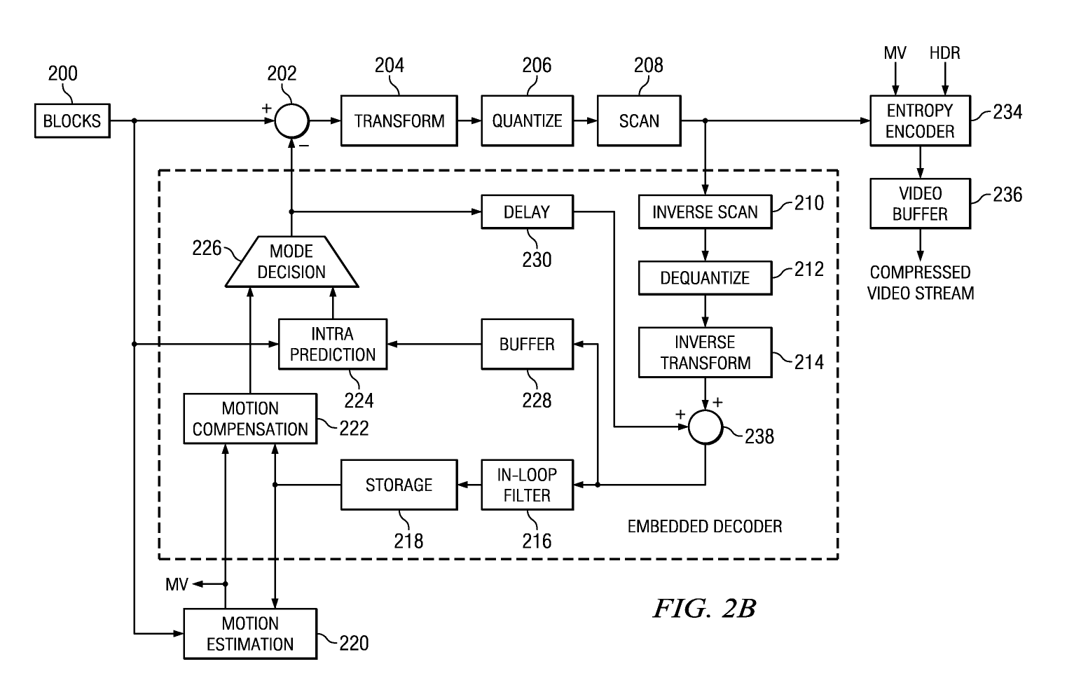

The video encoder component 106 receives a video sequence from the video capture component 104 and encodes it for transmission by the transmitter component 108. The video encoder component 106 receives the video sequence from the video capture component 104 as a sequence of pictures, divides the pictures into macroblocks, and encodes the video data in the macroblocks. The video encoder component 106 may be configured to apply a method for content-based adaptive control of intra-prediction modes during the encoding process as described herein. Embodiments of the video encoder component 106 are described in more detail below in reference to FIGS. 2A and 2B.

The transmitter component 108 transmits the encoded video data to the destination digital system 102 via the communication channel 116. The communication channel 116 may be any communication medium, or combination of communication media suitable for transmission of the encoded video sequence, such as, for example, wired or wireless communication media, a local area network, or a wide area network.

The destination digital system 102 includes a receiver component 110, a video decoder component 112 and a display component 114. The receiver component 110 receives the encoded video data from the source digital system 100 via the communication channel 116 and provides the encoded video data to the video decoder component 112 for decoding. The video decoder component 112 reverses the encoding process performed by the video encoder component 106 to reconstruct the macroblocks of the video sequence. The reconstructed video sequence is displayed on the display component 114. The display component 114 may be any suitable display device such as, for example, a plasma display, a liquid crystal display (LCD), a light emitting diode (LED) display, etc.

In some embodiments, the source digital system 100 may also include a receiver component and a video decoder component and/or the destination digital system 102 may include a transmitter component and a video encoder component for transmission of video sequences in both directions for video streaming, video broadcasting, and video telephony. Further, the video encoder component 106 and the video decoder component 112 may perform encoding and decoding in accordance with one or more video compression standards. The video encoder component 106 and the video decoder component 112 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIGS. 2A and 2B show block diagrams of a video encoder, e.g., the video encoder 106 of FIG. 1, configured to use content-based adaptive control of intra-prediction modes. FIG. 2A shows a high level block diagram of the video encoder and FIG. 2B shows a block diagram of the block processing component 242 of the video encoder.

As shown in FIG. 2A, a video encoder includes a coding control component 240, a block processing component 242, a rate control component 244, an intra-prediction set selection component 248, and a memory 246. The memory 246 may be internal memory, external memory, or a combination thereof. The memory 246 may be used, for example, to store information for communication between the various components of the video encoder.

An input digital video sequence is provided to the coding control component 240. The coding control component 240 sequences the various operations of the video encoder. For example, the coding control component 240 performs any processing on the input video sequence that is to be done at the picture level, such as determining the coding type (I, P, or B), i.e., prediction mode, of each picture based on the coding structure, e.g., IPPP, IBBP, hierarchical-B, being used. The coding control component 240 also divides each picture into macroblocks for further processing by the block processing component 242.

The coding control component 240 receives various information from the block processing component 242 as macroblocks are processed, from the intra-prediction mode selection component 248, and the rate control component 244, and uses this information to control the operation of various components in the video encoder. For example, the coding control component 240 provides information regarding quantization parameters determined by the rate control component 244 to various components of the block processing component 242 as needed.

In another example, the coding control component 240 receives information regarding the coding mode decision for a macroblock after the decision is made by the mode decision component 226. If the selected mode is an intra-prediction mode, then the coding control component 240 causes the intra-prediction set selection component 248 to accumulate activity statistics for the intra-coded macroblock. In another example, the coding control component 240 causes the intra-prediction set selection component 248 to select an intra-prediction set for a picture before the first macroblock in the picture is intra-predicted and provides an indication of the selected intra-prediction set to the intra prediction component 224 for use in intra-prediction of macroblocks in the picture. As is explained in more detail herein, the selection of the intra-prediction set is based on the accumulated activity statistics for intra-coded macroblocks from the previous picture.

The rate control component 244 determines a quantization parameter (QP) for each macroblock in a picture based on various rate control criteria and provides the QPs to the coding control component 240. The rate control component 244 may use any suitable rate control algorithm.

The intra-prediction set selection component 248 accumulates activity statistics of intra-coded macroblocks for a picture currently being encoded by the block processing component 242. More specifically, for each intra-coded macroblock in a picture, the intra-prediction set selection component 248 computes a macroblock activity measure and accumulates a running summation of the activity of intra-coded macroblocks in the picture, i.e., SumAct_IntraMB.

The intra-prediction set selection component 248 also selects an intra-prediction set for each picture from N predetermined intra-prediction sets and provides an indication of the selected set to the coding control component 240. For example, the intra-prediction set selection component 248 may indicate the selected set as a series of flags as illustrated in Table 3, where a 1 indicates that particular block size/mode is to be used for intra-prediction and a 0 indicates that the particular block size/mode is not to be used. To select an intra-prediction set, the intra-prediction set selection component 248 computes a measure of the activity in the intra-coded macroblocks in the previous picture, i.e., AvgAct_IntraMB, and uses this measure to select an intra-prediction set for the current picture from the N predetermined sets. Selection of an intra-prediction set based on intra-coded macroblock activity is previously described herein.

TABLE 3

| | Mode 0 | Mode 1 | Mode 2 | Mode 3 | Mode 4 | Mode 5 | Mode 6 | Mode 7 | Mode 8 |
|---|---|---|---|---|---|---|---|---|---|
| 16 × 16 | 1 | 1 | 1 | 1 | N/A | N/A | N/A | N/A | N/A |
| 8 × 8 | 1 | 1 | 1 | 1 | 1 | 1 | 1 | 1 | 1 |
| 4 × 4 | 1 | 1 | 1 | 0 | 0 | 0 | 0 | 0 | 0 |

Referring back to FIG. 2A, the block processing component 242 receives macroblocks from the coding control component 240 and encodes the macroblocks under the control of the coding control component 240 to generate the compressed video stream. FIG. 2B shows the basic coding architecture of the block processing component 242. The macroblocks 200 from the coding control component 240 are provided as one input of a motion estimation component 220, as one input of an intra prediction component 224, and to a positive input of a combiner 202 (e.g., adder or subtractor or the like). Further, although not specifically shown, the prediction mode of each picture as selected by the coding control component 240 is provided to a mode decision component 226, and the entropy encoder 234.

The storage component 218 provides reference data to the motion estimation component 220 and to the motion compensation component 222. The reference data may include one or more previously encoded and decoded macroblocks, i.e., reconstructed macroblocks.

The motion estimation component 220 provides motion estimation information to the motion compensation component 222 and the entropy encoder 234. More specifically, the motion estimation component 220 performs tests on macroblocks based on multiple temporal prediction modes using reference data from storage 218 to choose the best motion vector(s)/prediction mode based on a coding cost. To perform the tests, the motion estimation component 220 may divide each macroblock into prediction blocks according to the block sizes of prediction modes and calculate the coding costs for each prediction mode for each macroblock. The coding cost calculation may be based on the quantization scale for a macroblock as determined by the rate control component 244.

The motion estimation component 220 provides the selected motion vector (MV) or vectors and the selected inter-prediction mode for each inter-predicted macroblock to the motion compensation component 222 and the selected motion vector (MV) to the entropy encoder 234. The motion compensation component 222 provides motion compensated inter-prediction information to the mode decision component 226 that includes motion compensated inter-predicted macroblocks and the selected temporal prediction modes for the inter-predicted macroblocks. The coding costs of the inter-predicted macroblocks are also provided to the mode decision component 226.

The intra-prediction component 224 provides intra-prediction information to the mode decision component 226 that includes intra-predicted macroblocks and the corresponding spatial prediction, i.e., intra-prediction, modes. That is, the intra prediction component 224 performs spatial prediction in which tests based on multiple spatial prediction modes are performed on macroblocks using previously encoded neighboring macroblocks of the picture from the buffer 228 to choose the best spatial prediction mode for generating an intra-predicted macroblock based on a coding cost. To perform the tests, the intra prediction component 224 divides each macroblock into prediction blocks according to the block sizes and modes specified in the intra-prediction set selected by the intra-prediction set selection component 248 and calculates the coding costs for each specified block size/mode in the intra-prediction set. The coding cost calculation may be based on the quantization scale for a macroblock as determined by the rate control component 244. Further, the coding costs of the intra-predicted macroblocks are also provided to the mode decision component 226.

The mode decision component 226 selects a prediction mode for each macroblock based on the coding costs for each prediction mode and the picture prediction mode. That is, the mode decision component 226 selects between the motion-compensated inter-predicted macroblocks from the motion compensation component 222 and the intra-predicted macroblocks from the intra prediction component 224 based on the coding costs and the picture prediction mode. The output of the mode decision component 226, i.e., the predicted macroblock, is provided to a negative input of the combiner 202 and to a delay component 230. The output of the delay component 230 is provided to another combiner (i.e., an adder) 238. The combiner 202 subtracts the predicted macroblock from the current macroblock to provide a residual macroblock to the transform component 204. The resulting residual macroblock is a set of pixel difference values that quantify differences between pixel values of the original macroblock and the predicted macroblock.

The transform component 204 performs unit transforms on the residual macroblocks to convert the residual pixel values to transform coefficients and provides the transform coefficients to a quantize component 206. The quantize component 206 quantizes the transform coefficients of the residual macroblocks based on quantization parameters provided by the coding control component 240. For example, the quantize component 206 may divide the values of the transform coefficients by a quantization scale (Qs) selected based on the quantization parameter. In some embodiments, the quantize component 206 represents the coefficients by using a desired number of quantization steps, the number of steps used (or correspondingly the value of Qs) determining the number of bits used to represent the residuals. Other algorithms for quantization such as rate-distortion optimized quantization may also be used by the quantize component 206.

Because the DCT transform redistributes the energy of the residual signal into the frequency domain, the quantized transform coefficients are taken out of their scan ordering by a scan component 208 and arranged by significance, such as, for example, beginning with the more significant coefficients followed by the less significant. The ordered quantized transform coefficients for a macroblock provided via the scan component 208 along with header information for the macroblock and the quantization scale used are coded by the entropy encoder 234, which provides a compressed bit stream to a video buffer 236 for transmission or storage. The entropy coding performed by the entropy encoder 234 may be use any suitable entropy encoding technique, such as, for example, context adaptive variable length coding (CAVLC), context adaptive binary arithmetic coding (CABAC), run length coding, etc.

Inside the block processing component 242 is an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent pictures.

To determine the reconstructed input, i.e., reference data, the ordered quantized transform coefficients for a macroblock provided via the scan component 208 are returned to their original post-transform arrangement by an inverse scan component 210, the output of which is provided to a dequantize component 212, which outputs estimated transformed information, i.e., an estimated or reconstructed version of the transform result from the transform component 204. The dequantize component 212 performs inverse quantization on the quantized transform coefficients based on the quantization scale used by the quantize component 206. The estimated transformed information is provided to the inverse transform component 214, which outputs estimated residual information which represents a reconstructed version of a residual macroblock. The reconstructed residual macroblock is provided to the combiner 238.

The combiner 238 adds the delayed selected macroblock to the reconstructed residual macroblock to generate an unfiltered reconstructed macroblock, which becomes part of reconstructed picture information. The reconstructed picture information is provided via a buffer 228 to the intra-prediction component 224 and to a filter component 216. The filter component 216 is an in-loop filter which filters the reconstructed picture information and provides filtered reconstructed macroblocks, i.e., reference data, to the storage component 218.

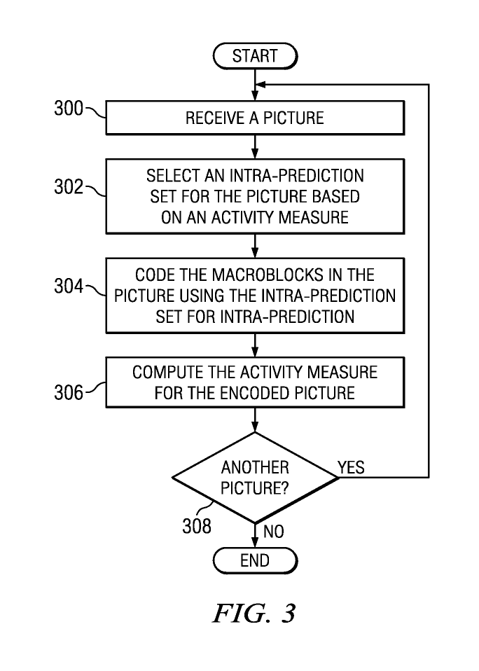

FIG. 3 shows a flow diagram of a method for content-based adaptive control of intra-prediction modes that may be implemented by the video encoder of FIGS. 2A and 2B. This method is described with respect to this video encoder merely for illustration. As will be apparent to one of ordinary skill in the art having benefit of the disclosure provided herein, the method can be implemented in other devices and using other components.

As shown in FIG. 3, initially a picture of a video sequence is received by the video encoder 300. An intra-prediction set is then selected for the current picture from N predetermined intra-prediction sets based on an activity measure 302. For most pictures, the activity measure used is the activity measure computed for the previously encoded picture as per step 306. However, if the picture is the initial picture in the video sequence, the activity measure is a predetermined value. If the picture is a scene change picture and/or the first picture after a scene change is detected in the video sequence, the activity measure may also be a predetermined value. Predetermined intra-prediction sets and selection of an intra-prediction set based on an activity measure are previously described herein.

The macroblocks in the picture are then coded using the selected intra-prediction set for intra-prediction 304. As the macroblocks are coded, when each macroblock in the picture is intra-predicted by the intra prediction component 224, only the intra-prediction block sizes and modes specified in the selected intra-prediction set are considered. Further, as the macroblocks are coded, activity statistics of the intra-coded macroblocks are accumulated for computation of the activity measure used to select an intra-prediction set for the next picture. That is, the intra-prediction set selection component 248 computes macroblock activity measures for each intra-predicted macroblock in the current picture and accumulates a running summation of the computed measure, i.e., SumAct_IntraMB.

After the current picture is coded, the activity measure for the encoded picture is computed 306, and the process is repeated for the next picture, if any 308. The activity measure of the intra-coded macroblocks of the encoded picture is computed as per Eq. 4. In general, the computation of the activity measure and the selection of the intra-prediction set are performed by the intra-prediction set selection component 248 upon request by the coding control component 240 at some time prior to the intra-prediction of the first macroblock in the next picture.

An embodiment of the method was evaluated in an H.264 video encoder for three sets of representative video sequences: a set of 1080p video sequences, a set of D1 video sequences, and a set of QCIF video sequences. Two coding structures were used for each set of video sequences, IPPP and IBBP, and the frame rate used was 30 frames per second. For evaluation purposes, six intra-prediction sets were used, i.e., the intra-prediction sets of Table 1. Minor PSNR (peak signal-to-noise ratio) degradation in the range of 0.01˜0.05 dB occurred in a small number of the test videos with scene changes and fade-in/fade-out. This degradation may be avoided by enabling all intra-prediction block sizes and modes for scene change or fade-in/fade-out frames. For the majority of the test video sequences, no PSNR degradation was observed. Further, significant computation savings over full intra-prediction with all block sizes and modes was observed. The average percentage of computation savings for each video resolution and coding structure is summarized in Table 4.

TABLE 4

| Video Resolution | IPPP | IBBP |
|---|---|---|
| 1080p | 20.5 | 18.6 |
| D1 | 21 | 23.8 |
| QCIF | 24.5 | 33.2 |

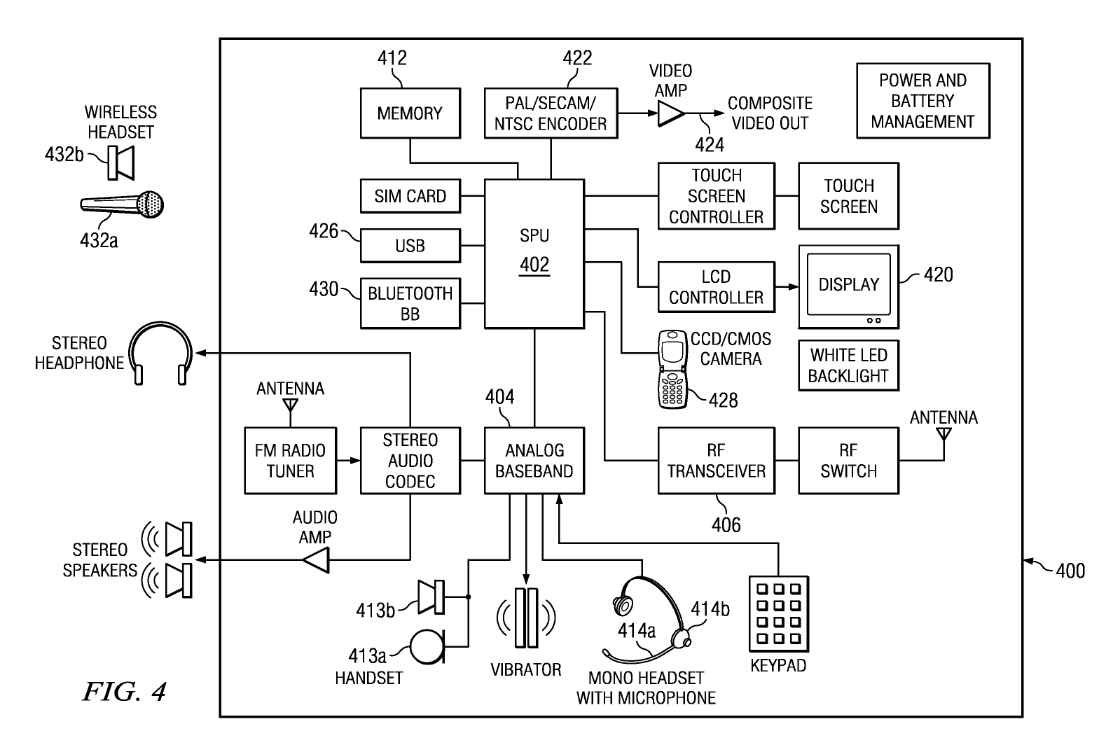

Embodiments of the methods and encoders described herein may be implemented for virtually any type of digital system (e.g., a desk top computer, a laptop computer, a tablet computing device, a handheld device such as a mobile (i.e., cellular) phone, a digital camera, etc.) with functionality to capture and encode a video sequence. FIG. 4 is a block diagram of a digital system (e.g., a mobile cellular telephone) 600 that may be configured to use techniques described herein.

As shown in FIG. 4, the signal processing unit (SPU) 402 includes a digital signal processing system (DSP) that includes embedded memory and security features. The analog baseband unit 404 receives a voice data stream from handset microphone 413a and sends a voice data stream to the handset mono speaker 413b. The analog baseband unit 404 also receives a voice data stream from the microphone 414a or 432a (via Bluetooth unit 430) and sends a voice data stream to the mono headset 414b or the wireless headset 432b. The analog baseband unit 404 and the SPU 402 may be separate integrated circuits. In many embodiments, the analog baseband unit 404 does not embed a programmable processor core, but performs processing based on configuration of audio paths, filters, gains, etc being setup by software running on the SPU 402.

The display 420 may also display pictures and video sequences received from a local camera 428, or from other sources such as the USB 426 or the memory 412. The SPU 402 may also send a video sequence to the display 420 that is received from various sources such as the cellular network via the RF transceiver 406 or the camera 428. The SPU 402 may also send a video sequence to an external video display unit via the encoder unit 422 over a composite output terminal 424. The encoder unit 422 may provide encoding according to PAL/SECAM/NTSC video standards.

The SPU 402 includes functionality to perform the computational operations required for video encoding and decoding. In one or more embodiments, the SPU 402 is configured to perform computational operations for applying one or more techniques for content-based adaptive control of intra-prediction modes during the encoding process as described herein. Software instructions implementing the techniques may be stored in the memory 412 and executed by the SPU 402, for example, as part of encoding video sequences captured by the local camera 428.

### Other Embodiments

While the invention has been described with respect to a limited number of embodiments, those skilled in the art, having benefit of this disclosure, will appreciate that other embodiments can be devised which do not depart from the scope of the invention as disclosed herein. For example, additional or differing prediction block sizes may be used and/or fewer, additional and/or different intra-prediction modes for the block sizes may be used. In another example, if multiple block sizes and modes are defined for the chroma components of macroblocks, the intra-prediction sets can be expanded to include chroma block sizes and modes. In another example, the intra-prediction set for a picture may be changed to a predetermined intra-prediction set if a scene change is detected while coding the picture.

While various embodiments have been described herein in reference to the H.264 video coding standard, embodiments for other coding standards will be understood by one of ordinary skill in the art. Such video compression standards include, for example, the Moving Picture Experts Group (MPEG) video compression standards, e.g., MPEG-1, MPEG-2, and MPEG-4, the ITU-T video compressions standards, e.g., H.263, H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), ITU-T/ISO High Efficiency Video Coding (HEVC) standard, etc. Accordingly, embodiments of the invention should not be considered limited to the H.264 video coding standard.

Embodiments of the video encoder and method described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope of the invention.

What is claimed is:

1. A method for encoding a video sequence in a video encoder, the method comprising:
receiving a picture in the video sequence;
selecting an intra-prediction set for the picture from a plurality of intra-prediction sets based on activity in a previous picture in the video sequence, wherein the intra-prediction set is a subset of intra-prediction block sizes and modes of the video encoder; and
coding the picture using the set of intra-prediction block sizes and modes for intra-prediction of macroblocks in the picture.

2. The method of claim 1, wherein selecting an intra-prediction set further comprises:
computing a measure of activity in intra-coded macroblocks in the previous picture; and
using the measure of activity to select the intra-prediction set from the plurality of intra-prediction sets.

3. The method of claim 2, wherein using the computed measure of activity further comprises:
comparing the measure of activity to one or more activity ranges corresponding to the plurality of intra-prediction sets; and
selecting the intra-prediction set when the measure of activity is within the activity range corresponding to the intra-prediction set.

4. The method of claim 2, wherein the measure of activity is based on average activity in the intra-coded macroblocks in the previous picture and a percentage of macroblocks in the previous picture that was intra-coded.

5. The method of claim 2, wherein the measure of activity is based on a sum of activity of the intra-coded macroblocks in the previous picture and a total number of macroblocks in the previous picture.

6. The method of claim 1, further comprising:
computing a macroblock activity measure for each intra-coded macroblock in the picture to generate a plurality of macroblock activity measures; and
selecting an intra-prediction set for a next picture from the plurality of intra-prediction sets based on the plurality of macroblock activity measures.

7. A digital system comprising a video encoder for encoding a video sequence, the video encoder comprising:
means for receiving a picture in the video sequence;
means for selecting an intra-prediction set for the picture from a plurality of intra-prediction sets based on activity in a previous picture in the video sequence, wherein the intra-prediction set is a subset of intra-prediction block sizes and modes of the video encoder; and
means for coding the picture using the set of intra-prediction block sizes and modes for intra-prediction of macroblocks in the picture.

8. The digital system of claim 7, wherein the means for selecting an intra-prediction set further comprises:
means for computing a measure of activity in intra-coded macroblocks in the previous picture; and
means for using the measure of activity to select the intra-prediction set from the plurality of intra-prediction sets.

9. The digital system of claim 8, wherein the means for using the computed measure of activity further comprises:
means for comparing the measure of activity to one or more activity ranges corresponding to the plurality of intra-prediction sets; and
means for selecting the intra-prediction set when the measure of activity is within the activity range corresponding to the intra-prediction set.

10. The digital system of claim 8, wherein the measure of activity is based on average activity in the intra-coded macroblocks in the previous picture and a percentage of macroblocks in the previous picture that was intra-coded.

11. The digital system of claim 8, wherein the measure of activity is based on a sum of activity of the intra-coded macroblocks in the previous picture and a total number of macroblocks in the previous picture.

12. The digital system of claim 7, wherein the video encoder further comprises:
means for computing a macroblock activity measure for each intra-coded macroblock in the picture to generate a plurality of macroblock activity measures; and
means for selecting an intra-prediction set for a next picture from the plurality of intra-prediction sets based on the plurality of macroblock activity measures.

13. A computer readable medium storing software instructions for coding of a video sequence, wherein execution of the instructions by a processor in a video encoder causes the video encoder to perform the actions of:
receiving a picture in the video sequence;
selecting an intra-prediction set for the picture from a plurality of intra-prediction sets based on activity in a previous picture in the video sequence, wherein the intra-prediction set is a subset of intra-prediction block sizes and modes of the video encoder; and
coding the picture using the set of intra-prediction block sizes and modes for intra-prediction of macroblocks in the picture.

14. The computer readable medium of claim 13, wherein selecting an intra-prediction set further comprises:
computing a measure of activity in intra-coded macroblocks in the previous picture; and
using the measure of activity to select the intra-prediction set from the plurality of intra-prediction sets.

15. The computer readable medium of claim 14, wherein using the computed measure of activity further comprises:
comparing the measure of activity to one or more activity ranges corresponding to the plurality of intra-prediction sets; and
selecting the intra-prediction set when the measure of activity is within the activity range corresponding to the intra-prediction set.

16. The computer readable medium of claim 14, wherein the measure of activity is based on average activity in the intra-coded macroblocks in the previous picture and a percentage of macroblocks in the previous picture that was intra-coded.

17. The computer readable medium of claim 14, wherein the measure of activity is based on a sum of activity of the intra-coded macroblocks in the previous picture and a total number of macroblocks in the previous picture.

18. The computer readable medium of claim 13, wherein execution of the instructions further causes the video encoder to perform the actions of:
computing a macroblock activity measure for each intra-coded macroblock in the picture to generate a plurality of macroblock activity measures; and
selecting an intra-prediction set for a next picture from the plurality of intra-prediction sets based on the plurality of macroblock activity measures.
